(19) United States
(12) Patent Application Publication
(10) Pub. No.: US 2002/0162806 A1
(43) Pub. Date: Nov. 7, 2002

(54) Inclined free water knockout (IFWKO)

(76) Inventor: Stephen Michael Komistek, Medicine Hat (CA)

Correspondence Address: Steve Komistek, Box 23071, Medicine Hat, AB, T1B 4C7, CA

(21) Appl. No.: 10/041,616

(22) Filed: Jan. 8, 2002

(30) Foreign Application Priority Data
May 4, 2001 (CA) 2,345,940

(51) Int. Cl. B01D 17/038

(52) U.S. Cl. 210/788; 210/800; 210/519; 210/539; 210/180; 210/187

(57) ABSTRACT

A free water knockout designed for removing large amounts of water that is not entrained in the oil is disclosed. The vessel is supported so that the axis is oblique through the horizontal, thus defining an upper and a lower end, each of which is closed by a head which may be hemispherical in shape. An elongated sleeve extends coaxially through the vessel to increase the surface area of the vessel relative to the volume of the vessel. Incoming fluids are spun tangentially to the wall of the elongated sleeve to help promote the separation of oil droplets from the water. A burner system is provided to add heat to the oil after the free water is removed from the production fluids.

### FIELD OF THE INVENTION

This invention relates to pressure vessels used to separate oil, water and gas. The separation process removes large volumes of water, but generally not all the water from the emulsion. Vessels of this type are commonly known as a Free Water Knockout (FWKO).

### BACKGROUND OF THE INVENTION

As oilfields age they produce more water. Some fields produce over 98% water of the total fluids produced. In order to be economical these large volumes of water have to be handled economically.

Factors that effect the separation of fluids are: retention time of the fluids, heating the fluid, adding chemicals to the fluid, and utilizing centrifugal forces. A good designed vessel minimizes the use of chemicals because chemicals increase the operating costs significantly. Increasing the efficiencies of a FWKO will enable it to be made smaller and reduce the capital cost significantly.

Freewater Knockouts can be vertical, horizontal or inclined at an oblique angle to the horizontal. To be an effective FWKO the vessel should minimize the channeling of fluids through the vessel, utilize centrifugal forces to promote separation, provide short cuts for the oil droplets to get combined with other oil after it is free of the water, and provide a lot of surface area relative to the volume of the vessel to promote coalescing.

### Prior Art

A prior patent of interest is U.S. Pat. No. 5,837,152 of Nov. 17, 1998 (Canadian Patent Application CA 2202210). This patent pertains to an inclined vessel which utilizes a slotted pipe to disperse fluids into the vessel, and it has a baffle plate near the bottom and a weir plate at the top.

The slotted pipe jets the fluid into the vessel and causes agitation at the top of the vessel, consequently the oil has problems with large carryovers of water going over the weir plate with the oil. The top of this vessel utilizes the highest part of this vessel for gas separation. The inclination of this vessel is needed to provide a small volume at the top of the vessel for a gas cap. If the vessel were horizontal the gas cap relative to the fluid region of the vessel would be very large. The baffle plate at the bottom of the vessel is used to impede oil droplets from exiting directly out with the water. The proprietary rights claimed to this patent are the slotted inlet pipe, the baffle plate at the bottom of the vessel, and the weir at the top of the vessel and the combination of all three working together.

Utilizing an inclined vessel is prior art and there is no proprietary rights that can be claimed by that feature, however the inclination of the vessel in this patent and the proposed patent have completely different purposes for the inclining the vessel.

### GENERAL DESCRIPTION OF THE INVENTION

The IFWKO utilizes centrifugal forces to separate the oil, water and gas while also causing the small oil droplets to coalesce when it enters the vessel. This spinning action eliminates turbulence and collisions which aids in the separation process. The spinning action of the fluid in the elongated sleeve eliminates any channeling and utilizes the total volume of the elongated sleeve. Oil droplets settle out in the elongated sleeve and form a coalescing region which helps strip out small oil droplets from the water. On the top of the elongated sleeve is a large opening which allows oil to exit out of the elongated sleeve. On the bottom of the elongated sleeve is also a large opening to let the water out of the elongated sleeve.

Oil and water droplets that rises out of the elongated sleeve travel between the shell of the vessel and the outside of the elongated sleeve. The large amount of surface area helps the coalescing of the oil and water. Water that gathers on the outside of the elongated sleeve now has a direct path down to the water in the lower part of the vessel by following the curvature of the elongated sleeve. Water drops to the bottom of the vessel and flows to the water outlet. Oil rises to the top of the vessel and flows to the oil exit.

Heat can be added to the oil region to aid the separation process by utilizing a firetube which is situated outside of the elongated sleeve, or by implementing heat tubes inside the elongated sleeve into the oil coalescing region.

### GENERAL DESCRIPTION OF THE DRAWINGS

One embodiment of this invention is illustrated in the accompanying drawings, in which like numerals denote like parts throughout the several views and in which:

FIG. 1 illustrates the side view and end view of the unheated IFWKO.

FIG. 2 illustrates the action of the fluid as it enters the elongated sleeve and centrifugal collector.

FIG. 3 illustrates the side view of the unheated IFWKO showing the oil coalescing section in the elongated sleeve.

FIG. 4 illustrates the top, side and end view of IFWKO utilizing a fire tube assembly.

FIG. 5 illustrates the top and side view of the IFWKO utilizing a heat tube assembly.

### DETAILED DESCRIPTION OF THE DRAWINGS

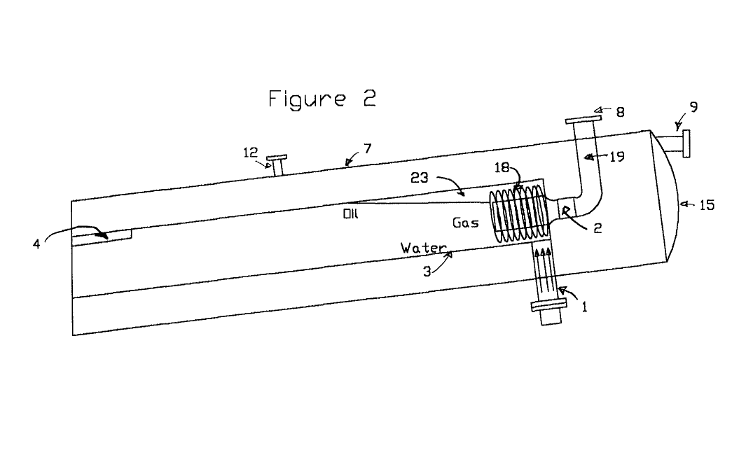

In FIG. 2 the production fluids enters the vessel at the inlet (1). Fluid flows up this conduit (1) until it intersects tangentially to the wall of an elongated sleeve (3), which is oblique to the horizontal. Inside the elongated sleeve (3) at the inlet (1) is a centrifugal collector (18) which is oblique to the horizontal and centered axially in the elongated sleeve (3). The centrifugal collector (18) dictates the inclination of the whole system.

The centrifugal collector is inclined to minimize the gas that can accumulate in the elongated sleeve (3) at region (23). The spiraling effect of the fluid as it passes the end of the centrifugal collector will funnel any gas in region 23 and the outside of the centrifugal collector into the centrifugal collector.

If the centrifugal collector were horizontal then the elongated sleeve (3) would also have to be horizontal so, that the centrifugal collector could be centered axially in the elongated sleeve (3). The elongated sleeve (3) being horizontal would allow the gas to travel down the elongated sleeve to the oil opening (4) and exit with the oil. Total gas separation in a horizontal elongated sleeve and horizontal centrifugal collector would not be possible.

Gas that is separated by the centrifugal collector or that is liberated from the oil enters the centrifugal collector passes oblique to the horizontal along a elongated sleeve (2) and then passes oblique to the vertical along a elongated sleeve (19).

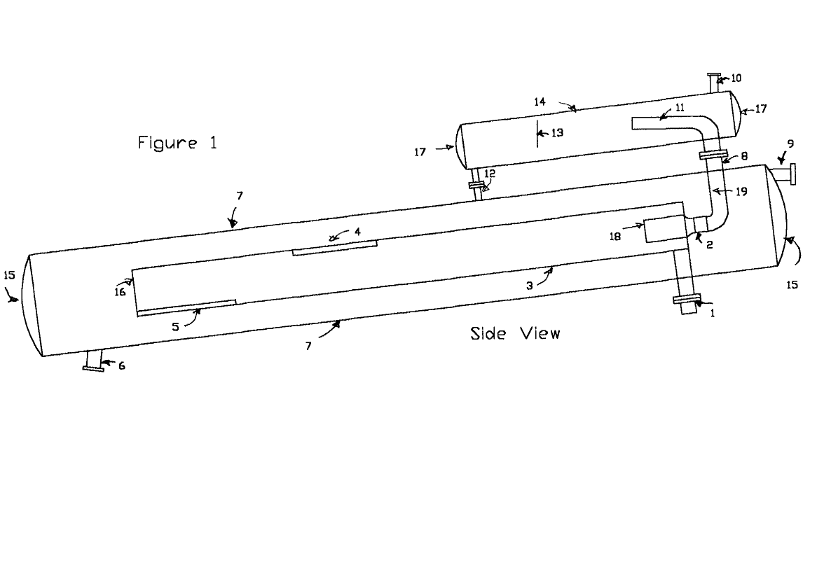

In FIG. 1 gas travels oblique to the vertical up a conduit (19) until it is directed horizontally along another conduit (11), where it enters a vessel (14) that is oblique to the horizontal. The vessel is closed by heads (17). Gas that exits this conduit (11) deflects off a plate (13) and the impact helps knock the liquids from the gas. The plate (13) allows fluids to pass over it and under it. Gas then rises and exits out the vessel through a nozzle (10) on the top of the vessel. Liquids that are separated from the gas drop to the bottom of the vessel and exit out of a nozzle (12) into the main vessel (7) where the liquids are rejoined with other liquids.

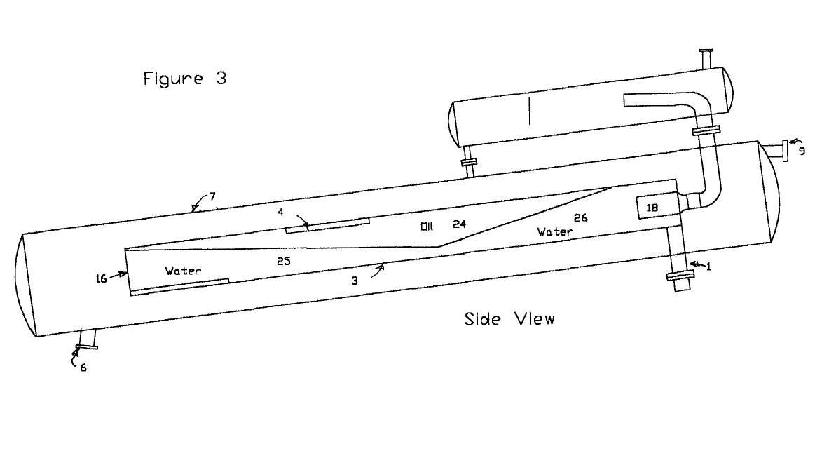

In FIG. 3 oil that is spun off the centrifugal collector (18) will travel near the center of the vortex and move directly towards the oil region (24). The spinning of the oil forces small oil droplets to coalesce and become larger oil droplets as it comes off of the centrifugal collector. The oil droplets will hit this oil region and coalesce into the oil region. A large surface area of oil is created so that any small oil droplets that hit this oil region are absorbed. As more oil is coalesced into the oil region it forces oil out of the oil opening (4).

In FIG. 1 oil now has to flow up the vessel in the volume between the vessel shell (7) and the outside of the elongated sleeve (3). This flow path creates a large surface area for the oil to cling to on the vessel shell (7) and also a large surface area for the water to cling to on the large elongated sleeve shell (3). Water droplets now have a place to gather and grow so when they get sufficient mass the large water droplets can move on the outside of the curvature of the large elongated sleeve (3). The large elongated sleeve (3) allows much more water droplets to be removed from the oil. If not for the outside of the large elongated sleeve, the water droplets would not get the size they need to get free from the oil. Once the water droplet moves down the curvature of the large elongated sleeve it joins up with the large volume of free water in the vessel. The water then travels down the vessel and exits out of the bottom nozzle (6).

The oil that comes out of the oil opening (4) travels up this annulus space between the vessel shell (7) and the large elongated sleeve (3) and exits out of the top nozzle (9).

In FIG. 3 water that comes off the centrifugal collector is gathered on the outside of the vortex. Since the flow coming into the inlet (1) is mostly water we develop an oily water region (26) at the end of the centrifugal collector. As the water loses angular velocity it drops to the bottom of the large elongated sleeve and flows down the incline of the large elongated sleeve. Oil droplets that are entrained in this water have a good chance to coalesce out into the oil region (24) as the water moves down to the bottom of the large elongated sleeve (3). The bottom part of the large elongated sleeve (3) is the water polishing region (25) where the oil concentration in the water is very low. The bottom of the large elongated sleeve is sealed (16) and water is allowed to exit out of the water opening (5). The water then travels down the vessel and exits out of the bottom nozzle (6).

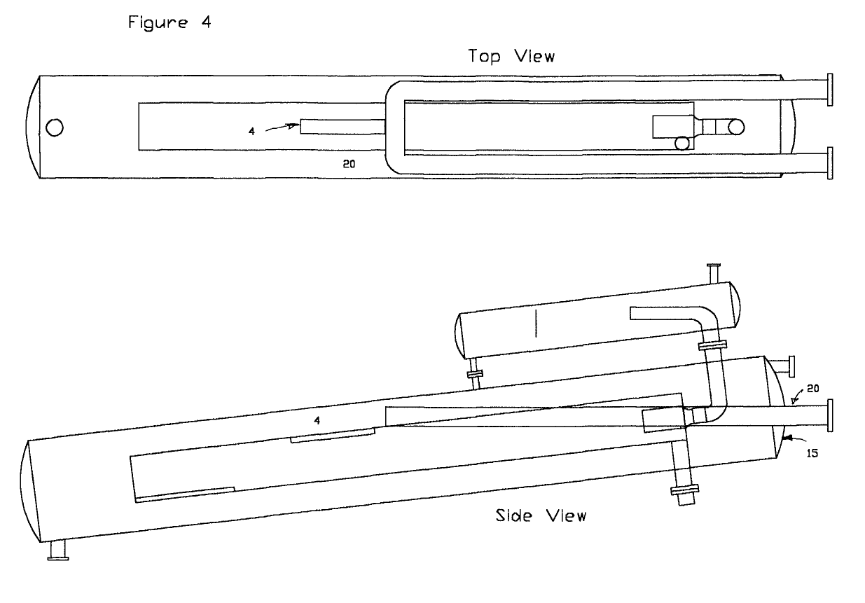

FIG. 4 illustrates the implementation of a firetube into the IFWKO. The fire tube (20) allows heat to be added to the fluid that comes into contact with the firetube. The ideal firetube puts as much heat has possible into the oil and as little heat as possible into the water. The firetube is horizontal and is installed into the head (15) of the vessel. The firetube heats the cleaner oil that comes out of the oil opening (4). This firetube system with the configuration of the IFWKO minimizes the amount of heat that is put into the water.

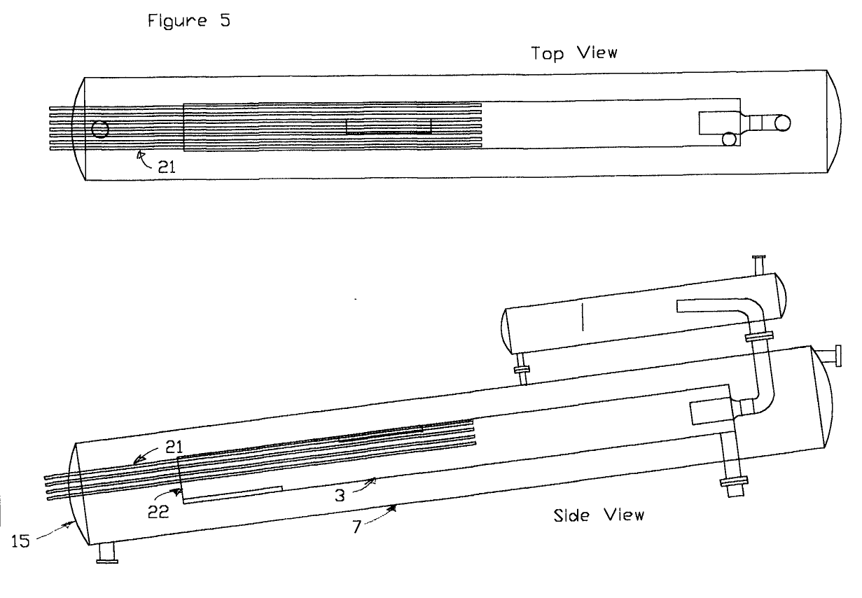

FIG. 5 illustrates the implementation of heat tubes (21) into the large elongated sleeve (3). The end of the large elongated sleeve (22) has an opening for the heat tubes to enter. The heat tubes are installed so the axis is oblique through the horizontal. The large elongated sleeve (3) runs parallel with the heat tubes and the vessel shell (7) runs parallel to the large elongated sleeve.

The embodiments of the invention in which an exclusive property or privilege is claimed are defined as follows:

1. A free water knockout vessel comprising:
an elongate vessel for receiving oil with gas and large quantities of free water that is not entrained in the oil, and for separating a percentage of the water and gas from the oil, the vessel having a longitudinal axis,
means for supporting said vessel such that the longitudinal axis is at an oblique angle to the horizontal, whereby the vessel has an upper end and a lower end,
a lower vessel head closing the lower end, and an upper head closing the upper end,
an elongate sleeve extending substantially coaxially inside said vessel and having an upper sleeve head which closes the top of the sleeve and a lower sleeve head which closes the bottom of the sleeve, with slots located on the bottom of the sleeve in the bottom portion of the sleeve, and slots located on the top of the sleeve at an intermediate position between the ends of the vessel,
a short sleeve extending substantially coaxially inside said elongated sleeve, which is open on the bottom end, and projects through said upper elongated sleeve head,
a elongated sleeve connects to said short sleeve and projects through said top portion of the vessel, at the top point of the vessel curvature,
fluid inlet means for admitting fluids to the elongate sleeve adjacent the upper sleeve end,
gas separator means for removing gas from fluid in the elongate sleeve,
oil outlet means adjacent the lower vessel head for removing water from the vessel.

2. The free water knockout in claim 1, in which the gas separator means is connected to substantially the short sleeve.

3. The free water knockout in claim 1, in which said oil outlet means is connected to substantially the highest location within the vessel, or the oil outlet can be placed at any orientation on the vessel by the use of a riser conduit.

4. The free water knockout in claim 1, in which the water outlet is connected to substantially the lowest location within the vessel, or the water outlet can be placed at any orientation on the vessel by the use of a downcomer conduit.

5. The free water knockout in claim 1, in which the elongated sleeve and vessel are substantially cylindrical and coaxial, all said heads being substantially hemispherical.

6. The free water knockout in claim 1, has a plurality of apertures adjacent its intermediate position and lower end.

7. The free water knockout in claim 1, orientates the inlet elongated sleeve such that it creates a cyclone, which forces the in coming fluid to move tangentially to the wall of the elongated sleeve and create centrifugal forces which help reduces the forces holding the water, oil and gas components together.

8. The free water knockout in claim 1, uses a short sleeve to intersect in to the center of the cyclone created by spinning the incoming fluids, and remove the gas component from the incoming fluid.

9. The free water knockout in claim 1, can be equipped with heat tubes that protrude through the lower head of the vessel, the lower head of the elongated sleeve, and run parallel to the longitudinal axis of the elongated sleeve.

10. The free water knockout in claim 1, can be equipped with fired tubes that protrude through the upper head of the vessel, the fired tube enters the vessel through the upper head and travels horizontal into the vessel to the desired penetration, it then turns 180 degrees and exits out the upper head of the vessel.

11. A method of removing free water from oil well production fluids, utilizing an elongate vessel having a longitudinal axis, a means for supporting said vessel such that the axis is at an oblique angle to the horizontal whereby the vessel has an upper end and a lower end, a lower vessel head closing the lower end, and an upper head closing the upper end, an elongate sleeve extending substantially coaxially inside said vessel and having an upper sleeve head which closes the top of the sleeve and a lower sleeve head which closes the bottom of the sleeve, with slots located on the bottom of the sleeve in the bottom portion of the sleeve, and slots located on the top of the sleeve at an intermediate position between the ends of the vessel, a short sleeve extending substantially coaxially inside said elongate sleeve, which is open on the bottom end, and projects through said upper sleeve head, a conduit connects to said short sleeve and projects through said top portion of the vessel, at the top curvature of the vessel, fluid inlet means for admitting fluids to the elongate sleeve adjacent the upper sleeve end, gas separator means for removing gas from fluid in the elongate sleeve, and oil outlet means adjacent the lower vessel head for removing water from the vessel; said method comprising simultaneously:
a) admitting oil well production fluids through the fluid inlet means,
b) allowing oil emulsion to be removed through said oil emulsion outlet means,
c) allowing water to be removed through said water outlet means, and
d) allowing gas to be removed from the elongated sleeve by the short sleeve means.
